(19) United States
(12) Patent Application Publication
(10) Pub. No.: US 2013/0142338 A1
(43) Pub. Date: Jun. 6, 2013

(54) Virtual Reality Sound Source Localization Apparatus

(71) Applicants: Pao-Chi Chang, Taoyuan County (TW); Kuo-Lun Huang, Chiayi County (TW); Tai-Ming Chang, Pingtung County (TW)

(72) Inventors: Pao-Chi Chang, Taoyuan County (TW); Kuo-Lun Huang, Chiayi County (TW); Tai-Ming Chang, Pingtung County (TW)

(73) Assignee: NATIONAL CENTRAL UNIVERSITY, Taoyuan County (TW)

(21) Appl. No.: 13/352,543

(22) Filed: Jan. 18, 2012

(30) Foreign Application Priority Data
Dec. 1, 2011 (TW) 100144247

(51) Int. Cl. H04R 5/00

(52) U.S. Cl. 381/17

(57) ABSTRACT

The present invention provides an apparatus with sound source localization. Spatial information and original audios are synthesized by a mono signal analyzer/synthesizer of a multi-channel system to obtain a three-dimensional (3D) virtual reality sound effect. By extracting and synthesizing spatial parameters, only original audio objects and spatial location data are required to obtain an effect of multi-channel spatial audio. Thus, a multi-channel playback system is formed with a small bit stream in transference to obtain Doppler effect on simulating moving of audio objects in real life.

### TECHNICAL FIELD OF THE INVENTION

The present invention relates to sound source localization; more particularly, relates to processing synthesis by using a mono signal analyzer/synthesizer of multi-channel system with spatial information and objects of original audios for obtaining a three-dimensional (3D) virtual reality sound effect used in a network having low bit rate transference.

### DESCRIPTION OF THE RELATED ARTS

Traditionally, for a multi-channel audio coding system, spatial audio effect is shown by transferring stored signal of each channel. But, as number of channels are increased, loading of network transference is increased. In actual life, when audio objects are moving in space, frequencies are changed according to the changes in relative locations between the audio objects and the hearer, which is called Doppler effect. Traditional multi-channel technologies mostly records and playbacks actual multi-channel sounds. Yet, for modern multi-channel technologies, spatial surrounding sound effect is modified at coding end in advance; or, simulated echo is added by a sound effect amplifier to obtain the surrounding sound effect. However, these effects do not totally resemble spatial audio effect for applying in active games.

Traditional prior arts uses head related transfer function (HRTF) to generate virtual reality audios. But, for forming moving effect of audios, convolution integrations have to be continuously calculated between the audios and the HRTF. Consequently, use load of memory is heavy, source of computer is greatly consumed and time for operation is long. Hence, the prior arts do not fulfill all users' requests on actual use.

### SUMMARY OF THE INVENTION

The main purpose of the present invention is to provide an apparatus for virtual reality sound source localization used in a network having low bit rate transference.

The second purpose of the present invention is to process synthesis by using a mono signal analyzer/synthesizer of multi-channel system with spatial information and objects of original audios for obtaining a 3D virtual reality sound effect.

The third purpose of the present invention is to generate multi-channel surrounding sound effect with spatial parameters transferred from a server at a very low bit rate.

To achieve the above purposes, the present invention is a virtual reality sound source localization apparatus, comprising a spatial parameter generator, a time-frequency analyzer, a dynamic-source Doppler effect modulator, a multi-channel signal synthesizer, a time-frequency synthesizer and a multiple audio object synthesizer, where the spatial parameter generator transforms data of distances between audio objects and a hearer into spatial parameters; the time-frequency analyzer analyzes the audio objects into a plurality of time-frequency signals of sub-bands (multi channels); the dynamic-source Doppler effect modulator is connected with the time-frequency analyzer; the dynamic-source Doppler effect modulator changes the time-frequency signals of the sub-bands based on locations, moving distances and moving speeds of the audio objects; the multi-channel signal synthesizer is of a multi-channel configuration; the multi-channel signal synthesizer is connected with the spatial parameter generator and the dynamic-source Doppler effect modulator; the multi-channel signal synthesizer synthesizes the audio objects with the spatial parameters into multi-channel time-frequency signals; the time-frequency synthesizer is connected with the multi-channel signal synthesizer; the time-frequency synthesizer synthesizes the time-frequency signals into multi-channel time-domain signals; the multiple audio object synthesizer is connected with the time-frequency synthesizer; and the multiple audio object synthesizer synthesizes the audio objects into a set of multi-channel output signals. Accordingly, a novel virtual reality sound source localization apparatus is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention; and

FIG. 2 is the structural view showing the network service application.

### DESCRIPTION OF THE PREFERRED EMBODIMENT

The following description of the preferred embodiment is provided to understand the features and the structures of the present invention.

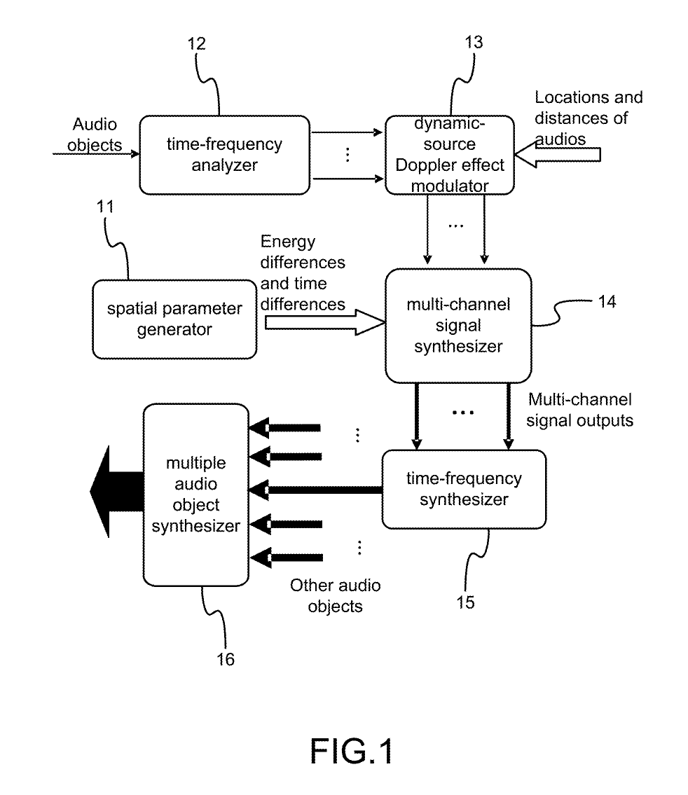

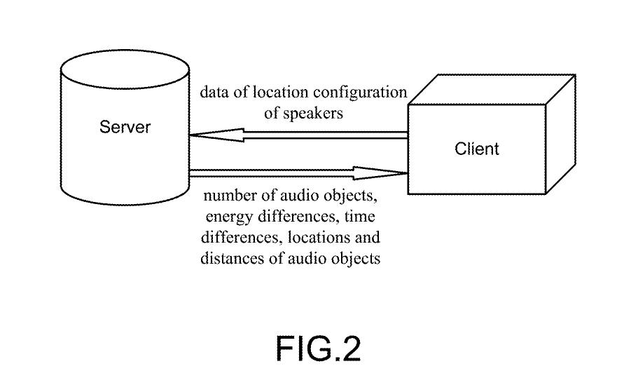

Please refer to FIG. 1 and FIG. 2, which are structural views showing a preferred embodiment and a network service application according to the present invention. As shown in the figures, the present invention is a virtual reality sound source localization apparatus, comprising a spatial parameter generator 11, a time-frequency analyzer 12, a dynamic-source Doppler effect modulator 13, a multi-channel signal synthesizer 14, a time-frequency synthesizer 15 and a multiple audio object synthesizer 16, where spatial information and original audios are synthesized by a mono signal analyzer/synthesizer of a multi-channel system for obtaining a three-dimensional (3D) virtual reality sound effect used in a network having low bit rate transference.

The spatial parameter generator 11 transforms data of distances between audio objects and a hearer into spatial parameters. That is, distances and angles between the audio objects and the hearer are transformed into energy differences and time differences between multi-channels. Therein, the energy differences and the time differences are generated on synthesizing audios of speakers of two channels.

The time-frequency analyzer 12 is a short-time Fourier transformer (STFT) or a complex-exponential modulated quadrature mirror filter (QMF), where the audio objects are analyzed into a plurality of time-frequency signals of sub-bands (multi channels). Therein, the sub-bands are formed through transformation by a hybrid analysis filter array based on a frequency resolution of a human auditory system; and, the hybrid analysis filter array is constructed to obtain an equivalent rectangular bandwidth (ERB) scale.

The dynamic-source Doppler Effect modulator 13 is connected with the time-frequency analyzer 12 to change the time-frequency signals of the sub-bands based on locations, moving distances and moving speeds of the audio objects.

The multi-channel signal synthesizer 14 is connected with the spatial parameter generator 11 and the dynamic-source Doppler Effect modulator 13 to synthesize the audio objects and the spatial parameters into time-frequency signals. That is, the time-frequency signals are generated with the audio objects and the energy differences and the time differences between multi-channels based on the multi-channel configuration.

The time-frequency synthesizer 15 is connected with the multi-channel signal synthesizer 14 to synthesize the time-frequency signals into multi-channel time-domain signals.

The multiple audio object synthesizer 16 is connected with the time-frequency synthesizer 15 to synthesize the audio objects into a set of multi-channel output signals.

Thus, a novel virtual reality sound source localization apparatus is obtained.

On using the present invention, data of a number of local audio players are provided by a client to a server, i.e. data of spatial parameters and audio objects. Then, data like motion of an online-game character, background audio, interactive audio, etc. are given to the client by the server after calculation. Therein, the audio objects are mono-channel audios and the spatial parameters are energy differences, time differences and relative locations between a user and an object (or another user).

The energy difference is expressed with the following formulas:

$${a}_{1 , b} = \frac{{A}_{b} \cdot {α}_{b} \cdot {a}_{s , b}}{( {A}_{b} \cdot p ( {q}_{b} ) + p ( 2 r {θ}_{0} - {q}_{b} ) )}$$

$${a}_{2 , b} = \frac{{α}_{b} \cdot {a}_{s , b}}{( {A}_{b} \cdot p ( {q}_{b} ) + p ( 2 r {θ}_{0} - {q}_{b} ) )}$$

The time difference is expressed with the following formulas:

d_{1,b}=q/c

d_{2,b}=(2rsin θ₀−q)/c

The sub-bands of dynamic audio are expressed by using a Doppler Effect modulator with the following formulas:

$${f}_{m , center}^{′} = {f}_{m , center} \times ( \frac{c \pm {v}_{o} ( k )}{c ∓ {v}_{s} ( k )} )$$

$$shift ( k , n ) = round ( \frac{{f}_{m , center}^{′} - {f}_{m , center}}{m - th {subband}^{′} s band size} )$$

Take four channels as an example. The multi-channel signal synthesizer in a multi-channel configuration is expressed with the following formula:

y_{i,m}(k)=δ(i-mod((l−1), I)).\hat{n}′_{1,m}(k−dn_{1,b})+δ(i-mod((l+2), I)).\hat{n}′_{2,m}(k−dn_{2,b})+δ(i-mod(l,I)).α_{1,b}.s_{b}(k−(d_{b}−d_{1,b}))+δ(i-mod((l+1), I)).α_{2,b}.s_{b}(k−(d_{b}−d_{2,b})).

Therein, l is a sequential number of a speaker in the configuration.

A network service application of the present invention is shown in FIG. 2. With all of the audio objects of environment for the client, the configuration of speakers is informed to the server. The server generates multi-channel spatial parameters (e.g. energy differences between channels, time differences between channels, sequential numbers of audio objects and locations of and distances between audio objects) to the client based on audio object locations in a virtual scene. After the client receives the spatial parameters, the data of the audio objects of the clients are read and are analyzed into signals of the sub-bands by the time-frequency analyzer. Then, the locations and moving speeds of the audio objects are analyzed to modulate frequencies for simulating Doppler Effect as moving audio objects in an actual scenario. Then, a multiaudio-multichannel virtual sound moving effect is generated at real time with the modulated mono signals and the spatial parameters by the multi-channel signal synthesizer. Thus, the hearer obtains virtual reality feelings of the moving of the audio objects in space by the speakers having multi-channels. Hence, the present invention uses the spatial parameters transferred by the server to generate a multi-channel surrounding audio effect for the hearer only with the least bit rate.

Accordingly, the present invention uses objects of multi-channel audios as input signals, i.e. a number of N input signals from a number of N objects. Each of the audio objects is transformed into time-frequency signal by the time-frequency analyzer and the frequency signals are adjusted according to spatial parameters for obtaining Doppler Effect to simulate moving of audio objects in real life. The amount of output signals is based on the number of speakers at terminal, where mono-channel audios are coordinated with the spatial parameters to be synthesized into multi-channel spatial audios for greatly reducing loading of network transference.

To sum up, the present invention is a virtual reality sound source localization apparatus, where, by extracting and synthesizing spatial parameters, only original audio objects and spatial location data are required to obtain an effect of multi-channel spatial audio; and a multi-channel playback system is thus formed with a small bit stream in transference to obtain Doppler effect on simulating moving of audio objects in real life.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A virtual reality sound source localization apparatus, comprising
a spatial parameter generator, said spatial parameter generator transforming data of distances between audio objects and a hearer into spatial parameters;
a time-frequency analyzer, said time-frequency analyzer analyzing said audio objects into a plurality of time-frequency signals of sub-bands;
a dynamic-source Doppler effect modulator, said dynamic-source Doppler effect modulator being connected with said time-frequency analyzer, said dynamic-source Doppler effect modulator changing said time-frequency signals of said sub-bands based on locations, moving distances and moving speeds of said audio objects;
a multi-channel signal synthesizer, said multi-channel signal synthesizer being of a multi-channel configuration, said multi-channel signal synthesizer being connected with said spatial parameter generator and said dynamic-source Doppler effect modulator, said multi-channel signal synthesizer synthesizing said audio objects with said spatial parameters into multi-channel time-frequency signals;
a time-frequency synthesizer, said time-frequency synthesizer being connected with said multi-channel signal synthesizer, said time-frequency synthesizer synthesizing said time-frequency signals into multi-channel time-domain signals; and
a multiple audio object synthesizer, said multiple audio object synthesizer being connected with said time-frequency synthesizer, said multiple audio object synthesizer synthesizing said audio objects into a set of multi-channel output signals.

2. The apparatus according to claim 1,
wherein said time-frequency analyzer is selected from a group consisting of a short-time Fourier transformer (STFT) and a complex-exponential modulated quadrature mirror filter (QMF).

3. The apparatus according to claim 1,
wherein said spatial parameter generator transforms distances and angles between said audio objects and said hearer into energy differences and time differences.

4. The apparatus according to claim 3,
wherein said energy difference is obtained on synthesizing audios of speakers of two channels.

5. The apparatus according to claim 3,
wherein said time difference is obtained on synthesizing audios of speakers of two channels.

6. The apparatus according to claim 1,
wherein said sub-bands are obtained through transformation by a hybrid analysis filter array based on a frequency resolution of a human auditory system; and said hybrid analysis filter array is obtained to have an equivalent rectangular bandwidth (ERB) scale.

7. The apparatus according to claim 1,
wherein said multi-channel signal synthesizer generates said time-frequency signals with said audio objects and energy differences and time differences between said audio objects based on said multi-channel configuration.
